(19) United States
(12) Patent Application Publication
(10) Pub. No.: US 2021/0398179 A1
(43) Pub. Date: Dec. 23, 2021

(54) DONEES AND DONORS MATCHING PLATFORM WITH DONEE VALIDATION AND NEEDS VERIFICATION

(71) Applicant: KOL Ventures LLC, Montclair, NJ (US)

(72) Inventors: Carey O'Connor KOLAJA, Montclair, NJ (US); Kyle Louis KOLAJA, Montclair, NJ (US)

(73) Assignee: KOL Ventures LLC, Montclair, NJ (US)

(21) Appl. No.: 17/075,115

(22) Filed: Oct. 20, 2020

Related U.S. Application Data
(60) Provisional application No. 63/040,143, filed on Jun. 17, 2020.

(51) Int. Cl. G06Q 30/06; G06Q 30/08; G06Q 30/02; G06Q 30/00; G06Q 10/06; G06Q 10/10; G06F 9/54; G06F 16/23

(52) U.S. Cl. CPC G06Q 30/0609; G06Q 30/08; G06Q 30/0279; G06Q 30/0185; G06Q 30/0201; G06N 20/00; G06Q 10/06315; G06Q 10/10; G06Q 30/0205; G06F 9/547; G06F 16/2365; G06Q 30/0633

(57) ABSTRACT

A donees and donors matching platform with donee validation and needs verification is provided. In some embodiments, the platform is a computer system for matching donors and donees comprising a processor, programmed with computer instructions, which when executed, cause the processor to: present a graphical user interface for matching donors and donees, including a portion for presenting an option for a donee to register with the system and a portion for presenting an option for the donee to state their needs; execute a validation algorithm to validate the donee's identity and the donee's stated needs; and present a graphical user interface portion that displays a validated donee's verified needs and a portion that presents an option for a donor to fulfill at least some of the verified needs.

### CROSS-REFERENCE TO RELATED APPLICATIONS

This application claims priority to U.S. Provisional Patent Application Ser. No. 63/040,143, filed Jun. 17, 2020, entitled “DONEES AND DONORS MATCHING PLATFORM WITH DONEE VALIDATION AND NEEDS VERIFICATION”, which is hereby incorporated herein by reference in its entirety.

### FIELD OF THE INVENTION

The invention relates to technology, in a platform for matching donors with donees (e.g., victims of natural and man-made disasters, crises, economic plight/uncertainty and other events or other donees), for verifying the claims and needs of the donees and avoiding fraud.

### BACKGROUND

Many people suffer from natural and man-made disasters and other events for which they need resources from donors. These victims have a variety of needs. Many organizations (e.g., public, private, for-profit, non-profit and other organizations) are focused on obtaining donations of money and other resources for these victims. Unfortunately, for various reasons, not all of the donated resources make it to the actual victims. Additionally, some unscrupulous people falsely claim to be victims, when they are not. Some are true victims but overstate their needs.

There are also market inefficiencies and limited transparency, between the needs of individuals impacted by a disaster (natural and man-made) and the good will of donors who aim to provide relief. This results in excessive in-kind waste, mis-direction of monetary funds, untapped human talent, and prolonged recovery. One of the greatest inefficiencies is with the matching the needs of people impacted and the good will of donors who want to provide relief. There's a common misconception that because people have lost everything, they must need everything, so donors send everything. Approximately 60% of individual in-kind donations are believed to go to waste.

Changes in communications and other technology have already made significant improvements in emergency management, yet there is still no way to holistically track people's needs, whereabouts, and state of recovery. Information asymmetry exists across the relief supply chain.

Some organizations have developed websites and other online resources to attempt to use technology to facilitate the identification of victims and the receipt of donations. However, an inherent problem with the use of online technology is that users can create fake accounts and fraudulently claim to be victims or overstate any actual needs. This is a problem that results from the difficulty of ensuring that users that create accounts are who they claim to be and that they have the needs they claim to have.

Another problem is that many people refrain from asking for help as they are embarrassed and uncomfortable, particularly with respect to asking for help from neighbors. These and other problems exist with known systems.

### SUMMARY OF THE INVENTION

One aspect of the invention relates to a technology platform for matching victims (or other donees) and donors that leverages technology and various algorithms to perform victim (or other donee) validation and needs verification. As used herein, donee is intended to broadly cover recipients of donations, financial aid or other economic benefit, relief from economic plight or uncertainty, debt or other relief of financial obligations and/or recipients of other assistance. The events leading to need is intended to broadly cover natural and man-made disasters, crises, economic plight/uncertainty and/or other events that adversely impact one or more individuals.

According to some embodiments, the invention comprises a connective platform that enables real-time relief, ensuring that the right resources get to the right people at the right time. One aspect relates to validating that those who claim to be victims are legitimate and that the claims they make regarding needs are verified. In part, this prevents the use of fake identities via the internet or the falsification of actual needs.

The validation may be done on individuals, their specific claimed needs and/or on alleged disasters or other events giving rise to needs of individuals. The validation may also be done on multiple individuals, families, groups, companies and other people or entities claiming a need for a donation of resources.

The validation(s) may be performed using a detection and decisioning algorithm (and/or an aggregate of sub-algorithms that are calculated based on provided and unprovided variables about the requester, claims and events). This may include automatically obtaining and/or updating data from the victim and other information from a variety of sources and applying a variety of algorithms to generate an Access Validity Score (AVS) used to assess a given individual's integrity/truth/worthiness for a specific requested good or service. The outcome of the AVS will be a continuous number yet may be used in a binary fashion to determine whether the relationship of a specific request is valid or invalid in accordance with a stored set of rules.

The metric can be used by a provider of a service or product, or access to an entity (rideshare/home/etc.) which potentially could be provided at discounted cost. Examples are provided below.

Some implementations of the system include a marketplace for matching victims and donors. The platform may include an ecommerce component for enabling victims to create an electronic shopping basket with specific items that the victim needs. Donors can identify a victim in need and purchase specific items on the victim's behalf through a trusted third party retailer who is validated as part of accessing the platform. Other implementations are feasible and the invention is not limited to this implementation.

Another aspect relates to resource verification and tracking. This enables verification and/or validation of resources (e.g., products, services and other resources). Another aspect relates to disaster (and other event) tracking and monitoring to enable verification and categorization of events and profiling their impact. Another aspect relates to an analytics component with machine learning component to enable quantitative and qualitative data capture and analysis, the creation of impact, needs and recovery scores and transaction and operations performance management and optimization.

User (impacted and donor) validation is a core platform functionality. Fraud and risk scores may be used to ensure genuine resources are applied to qualified individuals. To facilitate this, the system may store a set of rules for generating a needs score and/or other scores (e.g., Impact score, recovery score).

For companies, individuals or other entities that want to help, but do not know how to leverage their products, services, talent and/or other resources, the platform enables them to recommend or offer public and private resources so they can be added to the platform.

The system of the invention has many advantages as set forth herein and others as will be apparent from the description contained herein. In addition to those mentioned elsewhere, the advantages include transparency in donee claims, donor resources and the actual distribution of money and resources to people and other entities who claim a need.

In some scenarios, it may be desirable to protect the anonymity of the recipient while still preventing fraud. To accomplish this the system may enable the capability of connecting donees and donors while keeping protecting the verified identity of the donee. This may be done using a variety of known or hereafter developed technologies that enable online platforms to connect two or more parties anonymously.

These and other objects, features, and characteristics of the system and/or method disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example of an overview of a functional block diagram of a platform for matching donors with donees and verifying the claims and needs of the victims and avoiding fraud.

FIG. 2 illustrates an example of a user interface that displays an example of a set of supported events for the platform.

FIG. 3 illustrates an example of a user interface that displays an example of a various steps for a donee to get help via the platform.

FIG. 4 illustrates an example of a user interface that displays a shopping basket of resources selected by a donee via the platform.

FIG. 5 illustrates an example of a user interface that displays additional information needed in connection with a shopping basket of resources selected by a donee via the platform.

FIG. 6 illustrates an example of a user interface that displays an example of a various steps for a donor to give help via the platform.

FIG. 7 illustrates an example of a user interface that displays a shopping basket of resources selected by a donor via the platform.

FIG. 8 illustrates an example of a user interface that displays an example of a third party integration via an API or link that enables the purchase of shopping basket of resources selected by a donor via the platform through an ecommerce platform or other provider of good or services.

FIG. 9 illustrates an example of a user interface that displays an example of a partner sign up screen.

### DETAILED DESCRIPTION

It will be appreciated by those having skill in the art that the implementations described herein may be practiced without these specific details or with an equivalent arrangement. In other instances, well-known structures and devices are shown in block diagram form in order to avoid unnecessarily obscuring the implementations of the invention.

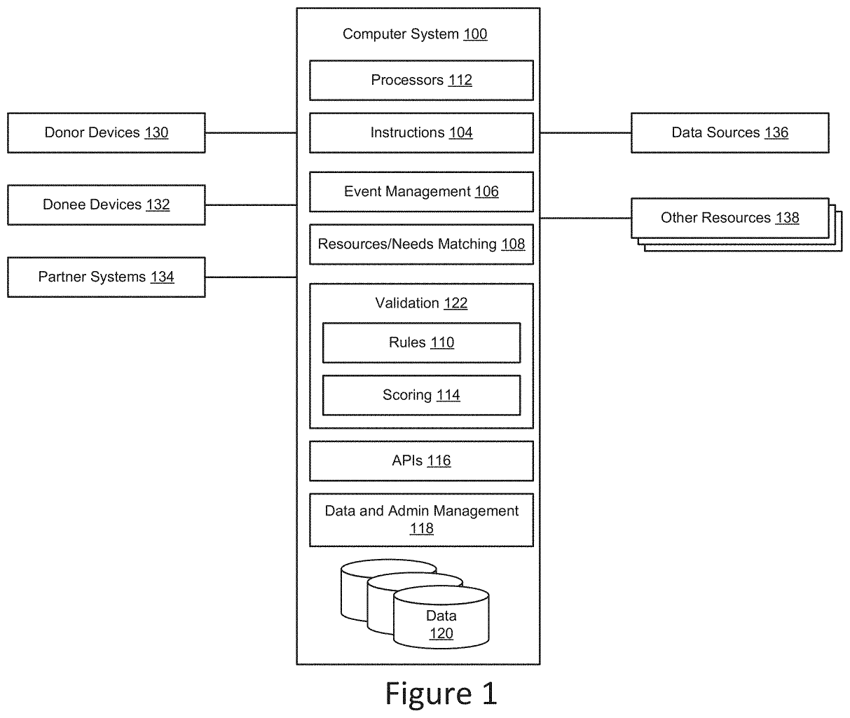

FIG. 1 illustrates an example of an overview of a functional block diagram of a platform for matching donors with donees and verifying the claims and needs of the victims and avoiding fraud. The platform may be implemented as a computer system 100 that includes processors 112, instructions 104, and data 120. The platform 100 may comprise an event management module 106 for managing supported events, a resources/needs matching component 108, and a set of APIs 116 to an ecommerce platform (and systems for obtaining other resources). The platform 100 may comprise a validation module 122, which may comprise a rules engine 110 for creating and storing rules relating to needs verification, a scoring module 114 for generating needs scores and a data management module 118 for obtaining, managing and storing data needed by the system. The platform 100 may communicate with donor devices 130, donee devices 132, partner systems 134, data sources 136, and other resources 138.

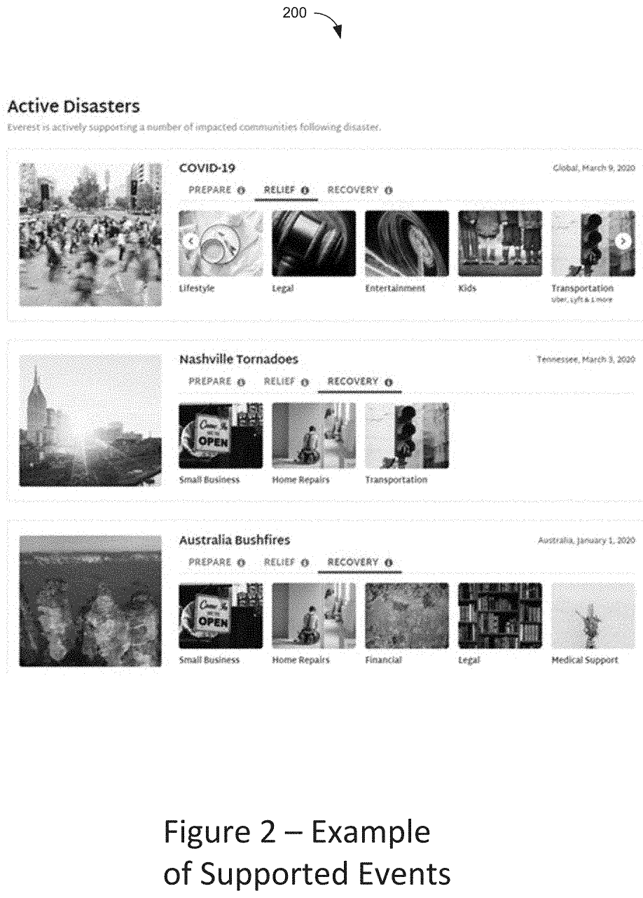

The event management module 106 for managing supported events may enable the creation of events to be supported by the system. One or more event templates may be created, stored and used to provide a consistent set of information and rules for various event types. Examples of some events are shown in FIG. 2, for example. Each event may be created, managed and stored in the system. For each event, the system may store event information including event type and information regarding the scope, magnitude, geographic scope and other event information. For each event, the UI may display one or more resource types.

The resources/needs matching component 108 may comprise a set of graphical user interfaces that may enable donees to identify their needs and publish this information through the system and graphical user interfaces that may enable donors to find the donees, view their needs, select a donee and make resources available to meet the donee's needs. Examples of sample interfaces are provided below.

The system may also include a set of APIs 116 to an ecommerce platform and/or other systems for obtaining other resources. For example, an API may connect to an ecommerce system of a validated partner (e.g., an online retailer) such that donees can select available resources (e.g., products or services) that they need and add them to an ecommerce basket. When a donor elects to provide some or all of the resources to the donee, the donor may select the basket (and/or portions thereof) and buy the items through the online retailer. The system APIs facilitate the ability for donors select the items and automatically be connected to the ecommerce platform.

According to another aspect of the invention the system may include a rules engine 110 for creating and storing rules relating to needs verification and a scoring module for generating needs scores. The rules may be electronically stored rules relating to validating events and a donee's stated needs. Examples of some of the type of rules are described below. The scoring module 114 may be used to generate one or more scores by applying the rules for a given event type using data about the event and the individual donee. Examples of some of the types of scores are described below.

According to another aspect of the invention the system may include a data management module 118 for obtaining, managing and storing data needed by the system. The data may include data about events, donors, donees, resources, and partners, among other types of data. The data may include data entered into the system by system administrators, donors, donees and partners. It may also include data automatically obtained by the system, including for example, data obtained about donee's from publicly available sources to verify the claimed needs of donees.

With reference to FIG. 2, for example, the system may include programming instructions to provide a set of UI display elements 200 that may enable users to select an event. Upon selecting an event, the UI may display one or more resource types associated in the system with that event. Upon selecting a resource type, the system may display a set of UI display elements 200 that provide a display and link to source of the resources (e.g., an online retailer, a transportation provider and or other sources of resources).

According other technical aspects of the invention, the system may include a resource filter module 108 that includes programming instructions to determine the suitability of resources for a selected event, e.g., the goods and services based on the likely needs of donees based on a variety of factors, including for example, the event characteristics, the locale of the event and/or other factors. Additionally, the system may include programming instructions 104 to calculate a needs score for different donees and provide a relative ranking to determine the donees most in need. Based on the ranking, the system may include programming instructions to display the donees with greater need in a higher ranked position. Other techniques may be used to ensure that the resources flow to those individuals most in need first.

By way of example the system may include programming instructions to make a determination of the suitability of needs to determine whether a set of available goods and services are suitable for the donee, prior to the donee explicitly requesting support (e.g., placing the goods or services in their basket) for a said item. Similar to the financial sector where a customer is assessed for “suitability” of a loan or financial aid, a suitability micro-score may be generated to determine the needs of a donee based on a variety of factors. The needs micro-score may be used by programming instructions to determine what is displayed and/or accessible to the donee on the platform. The programming instructions may be configured such that the platform does not display or make available to the donee resources (e.g., goods or services) that are not deemed within reason for the donee's impact claim and/or where the good or service benefit does not outweigh the cost. By way of example, the score may take into account information about the donee prior to the event, the impact of the event and the likely current needs of the donee based on the event. In the case of a loan, a loan for 250K would not be rendered to an individual on the platform who has debt of 100K, and no secured assets that exceed the value of the loan.

By way of further example the system may include programming instructions to make a determination of the, the calculation of the score may take into consideration various factors, including for example:
Financial Score: relative financial suitability based on value of the net worth, assets and/or prior lifestyle of the individual
Urgency of Critical Resources Score: relative value of items that are most needed based on trending analysis
Relative ranking of the request based on hierarchy of needs based on event impact
   Other factors may be used and different factors may be used based on different events and needs.

By way of example the system may include programming instructions to make a determination of the relative ranking of needs scores. For example, the system may calculate a stack ranking of donees from most urgent and eligible to least urgent and eligible. Based on urgency and/or eligibility, donees request may be stacked rank (e.g., similar to the result set from a google search), validating that donees with the most urgent needs (e.g., food, water, pharmacy) are met first. Once basic needs are met, prioritization may be determined based on the categorization of necessary and discretionary human needs. The platform 100 may systematically, and continuously rank each donee and/or donee request as new information is provided and the population of events and donees evolve. The algorithm may create a relative ranking taking into consideration, for example, the following:
Access Verification Score
Suitability of Needs Score
Eligibility of Needs
Relative aggregate cost of needs [asking or 1M worth of needs or 1K]
Alternative Contributions programs [insurance, local community activity, family associated, unemployment]

Similar to student financial aid, donees will be ranked, continuously, allowing for the individuals with the most urgent needs to be surfaced and fulfilled first, accelerating a faster path to recovery.

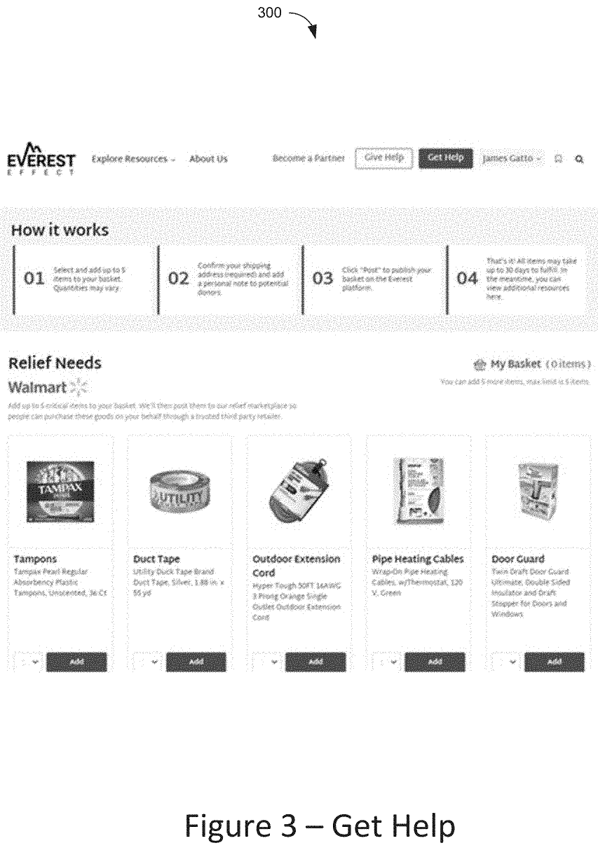

As shown for example in FIG. 3, the system may display a set of UI display elements 300 that provide users an option to select to give help or select to get help. When a user (donee) selects a display element 300 to get help, a UI may be presented that explains the steps to a user. As one example, if the user needs to purchase items, the UI may display products that are available from a source (e.g., an online retail partner or any other entity or service provider affiliated with the system). The user may select needed items, subject to system enforced rules (e.g., max number of items, max value of items and/or other rules).

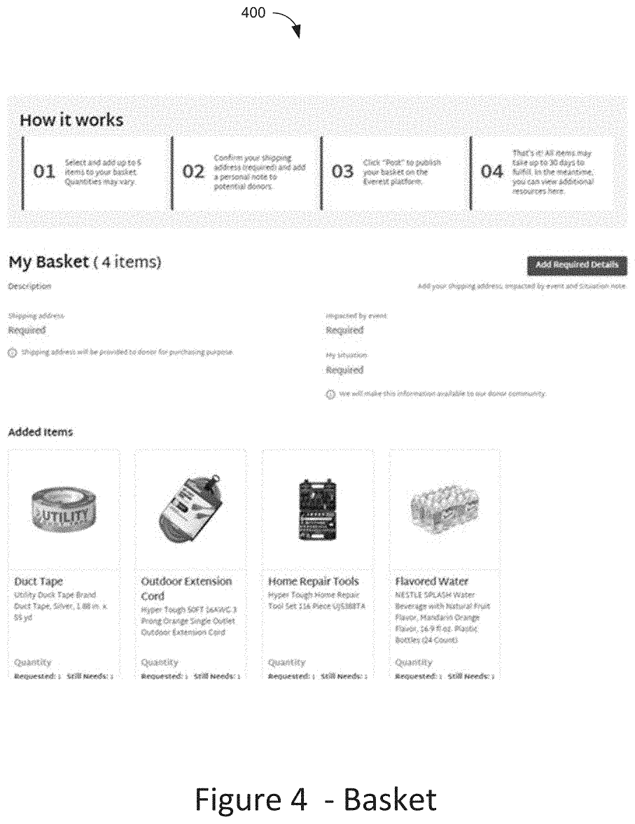

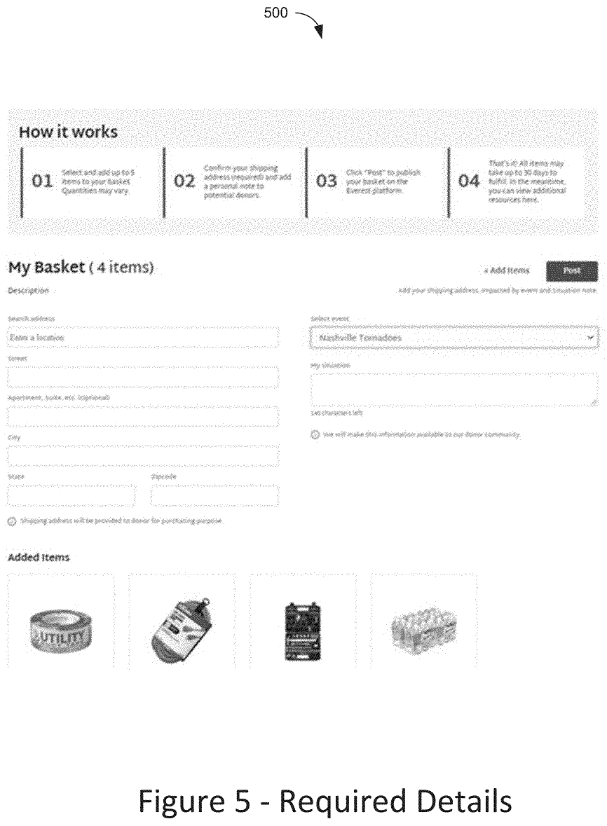

As shown for example in FIG. 4, the user selected items are stored and presented in the user's basket 400. As shown for example in FIG. 5, the user may also be prompted via display elements 500 to provide various required information (shipping address, event impacted by, information regarding their situation and/or other information). Subject to automated verification of the donees request, the donee's basket may be posted to the system so that donors can find the basket and provide resources.

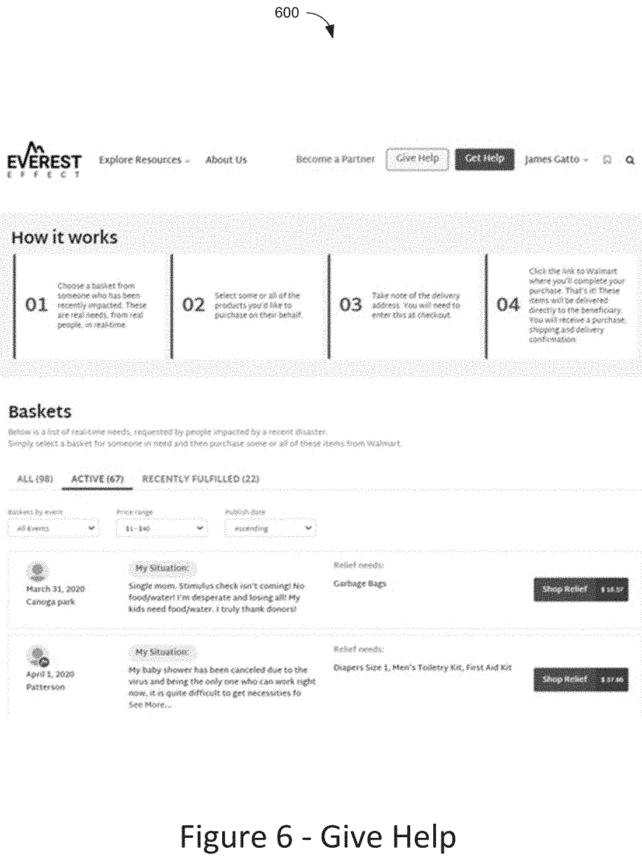

As shown for example in FIG. 6, when a donor selects to give help, the system may display a set of UI display elements 600 that may be presented to explain the steps to a user and show active and fulfilled baskets. Various search tools may be used to search for baskets by various search criteria (e.g., by event, by price range, by published date and/or other criteria).

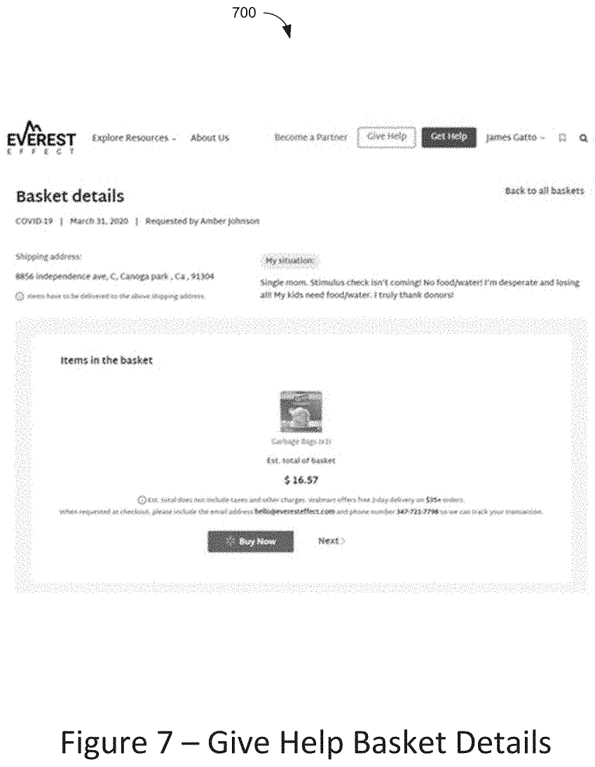

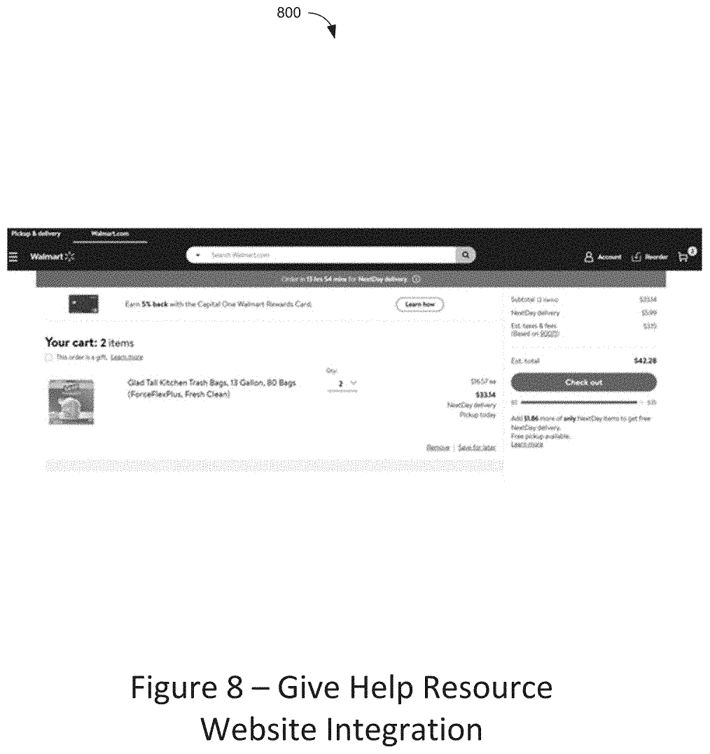

As shown for example in FIG. 7, when a donor selects a basket, the details of the basket are displayed with a buy now option 700. Selection of the buy now option may redirect to the source of the items in the basket (e.g., on online retailer) for the donor to complete the transaction by purchasing the basket or portion thereof as shown for example at 800 in FIG. 8.

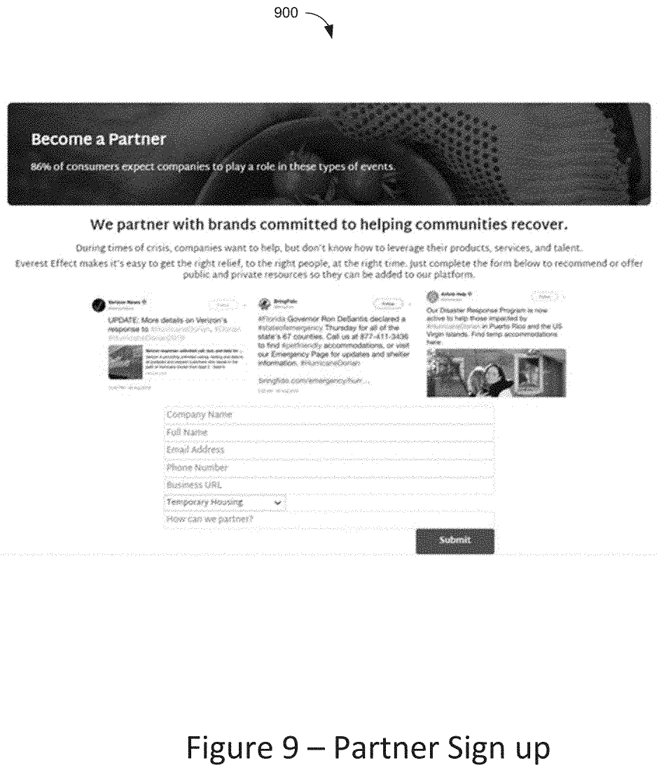

FIG. 9 displays an example of a partner sign up 900 to facilitate the ability for sources of resources to register with the system so that they can be validated. Information about the partners and/or APIs to their websites or other systems may be provided.

An important technology tool that the system may use is a validation module 122 (FIG. 1). The validation(s) may be performed using a detection and decisioning algorithm (and/or an aggregate of sub-algorithms that are calculated based on provided and unprovided variables about the requester, claims and events). This may include automatically obtaining and/or updating data from the victim and other information from a variety of sources and applying a variety of algorithms to generate an Access Validity Score (AVS) used to assess a given individual's integrity/truth/worthiness for a specific requested good or service. The outcome of the AVS will be a continuous number yet may be used in a binary fashion to determine whether the relationship of a specific request is valid or invalid in accordance with a stored set of rules.

By way of example, the tables below show some of the variables and micro-scores. While the AVS may be an aggregate score of a collection of micro-scores; micro-scores will be generated to inform the AVS and/or to be used independently. The term AVS is used for convenience of reference only. The scores may include a variety of types of scores that are generated according the rules stored in the system.

To facilitate this, according to another aspect of the invention, the system may include a rules engine 110 for creating and storing rules relating to needs verification and a scoring module for generating needs scores. The rules may be electronically stored rules relating to validating events, donee's stated needs, donors resources, and/or other items to be validated. Examples of some of the type of rules are described below. The scoring module 114 may be used to generate one or more scores by applying the rules for a given event type using data about the event and the individual donee and other factors as desired. Examples of some of the types of scores are described below. Application of the scores may be determined by use case, context, and economic value of request.

Nodes of related variables which could be used to derive a particular AVS score may include but are not limited to, type of request, the context surrounding request, explicit data inputs, inferences, known fraud scores to validate or invalidate the claim when triangulated around what is a known truth, i.e., did an event in said location occur and was the individual impacted in such a manner as to be rendered in need of help.

EXAMPLE: Calculating the access verification score that a family of X living in Y city lost all belongings in a Z disaster. Result set is a score that would validate that said family's need for critical resources.
Cal A: Validity that Disaster Occurred
Cal B: Probability that individual Impacted
Cal C: Credibility of the magnitude of individual impact
Cal D: Weighted value of need ask based on raw value of total requests
Cal E: Confirmation of individual identity

| | | | Value | |
|---|---|---|---|---|
| | Measurement | Variable Inputs | Output | Weight |
| A | Disaster | Disaster Tracking Data | Binary: | .10 |
| | Occurred | Trending Searches Google | 1 or 0 | |
| | | State of Emergency Declarations | | |
| | | Fed \| Local | | |
| B | Proximity to | Average Radius Maximum | Score | .20 |
| | Disaster | Wind \| of Disaster Type | 1-10 | |
| | | Address of Individual & | | |
| | | GPS \| IP of Individual Device | | |
| | | Address within 80% radius | | |
| | | Incidence of Insurance Claims | | |
| | | Relative to Location | | |
| C | Magnitude of | User submitted requests | Score | .30 |
| | Disaster | Pictures of user assets | 1-10 | |
| | Impact | Average of Value of Insurance | | |
| | | Claims Related to Disaster | | |
| D | Validity of | Requested needs | Score | .30 |
| | Requests | Pictures of impacted assets | 1-10 | |
| | | Total value of requests | | |
| | | Quality of life pre disaster | | |
| E | Confirmation | Email Address | Score | .10 |
| | of Identity | Phone Number | 1-10 | |
| | | Address Validation | | |

| | |
|---|---|
| TOTAL ACCESS VERIFICATION SCORE | # |

The output of AVS will be used to decision and approve the request of the individual in accordance with rules stored in the system (e.g. that the score is greater than some threshold).

### Example Input Variables

The following are examples of variables that may be used. This is not a comprehensive list. Other variables may be used. This also shows an example of a source for the information and the variable type. For the variable types stored in the system, the system may store and use the source to identify from where the system may obtain the data.

| Variable | Sample Source | Variable Type |
|---|---|---|
| Name | System | Explicit |
| Phone Number | System | Explicit |
| Email Address | System | Explicit |
| Physical Address | System | Explicit |
| Pre/Post Paid Phone Plan | Payfone | Implicit |
| #Children | Census | Implicit \| Explicit |
| #Dependents | Census | Implicit \| Explicit |
| Kids Ages | Census \| Commerce Trxs | Implicit \| Explicit |
| Homeowner | Plaid | Implicit |
| Mortgage Value | Plaid | Implicit |
| Professional Title | LinkedIn | Implicit |
| Tenure With Company | LinkedIn | Implicit |
| Self Employed | LinkedIn | Implicit |
| Average Income | GlassDoor | Implicit |
| Car Owner | Insurance Provider | Implicit |
| Car Type \| Age | Insurance Provider | Implicit |
| Uber/Lyft Rating | Uber/Lyft | Implicit |
| AirBnB Rating | AirBnB | Implicit |
| Quality of Life | Facebook \| Instagram | Implicit |
| Credit worthiness | Credit Scores \| Alternatives | Implicit |
| Cash on Hand | Plaid | Implicit |
| EE Needs Request | System | Explicit |
| Damaged Goods | TruePic | Explicit |
| Unemployment claims | Government | Implicit |
| Fraud Complaints | Federal Trade Commission | Implicit |
| Transportation Patterns | Waze \| Google Maps | Implicit |
| Insurance Policy (personal | Insurance Provider | Explicit |
| items or umbrella coverage) | | |
| Velocity of insurance Score | Insurance Provider | Explicit |
| Facebook or instagrams | Facebook \| Twitter | Implicit |
| Twitter word monitoring | | |
| Credit Loan Debit | Plaid | Explicit |
| Spending Categories | Plaid | Implicit |
| Complaints On Social Platform \| Rating | Social media | Implicit |
| Score Uber\|AirBnB\|Upwork\|Fiveer | | |
| Device Data [IP, Type] | Payfone | Implicit |
| Area Zipcode Event Proximity | Disaster Proximity \| Zillow | Implicit |
| Average Home Value | | |
| Proximity to Disaster | https://www.dataminr.com/ | Implicit |

### Example of Micro-Scores

| | |
|---|---|
| Urgency of In- | Type of Event |
| demand Critical | Historical Data on Most In-demand Needs |
| Services | Trending Data on Most In-demand Needs |
| | Contextual Categories In-demand Needs |
| | Severity of Impact Relative To Others |
| Financial Score | FICO |
| | Alternative Score |
| | Liquidity \| Balance |
| | Financial Institutions |
| Mobility Score | Commuting Patterns |
| | Most Frequent Modality of Movement |
| | Vehicle Ownerships |
| | Auto Insurance |
| Medical Score | Frequency of Visits |
| | Age and History |
| | Pre Existing Conditions |
| | Prescriptions |
| | Chronic or Acute Conditions |
| | Medical Insurance |
| Infrastructure | Dwelling Address |
| Score | Value of Dwelling |
| | Basics Pre-Event |
| | Property Insurance |
| | Personal Insurance |
| Commerce Score | Necessity vs. Discretionary Spend |
| | Brands Purchased More Frequently From |
| | Channel of Buying |
| Social Score | Twitter Followers |
| | LinkedIn Followers |
| | FB\|Insta\| Followers |
| | Contacts |
| | Average Messages |
| | Breath of Network |
| Behavioral Score | Assisting Others |
| | Context Tweets \| Retweets |
| | Charity Associations |
| | Donations Patterns |
| | Media Mentions |
| | Actions in NextDoor |
| Food Insecurity | Food Supply [Foodbank, Schools, Home] |
| Score | Food Choices |
| | Frequency of Dining Out |
| | Average Cost Per Meal |
| | FoodStamps Used |
| Identity Score | Government ID |
| | Tax ID \| SSN |
| | 3rd Party Verification |
| | Social Links |
| Criminal | PEP \| Sanctions |
| Activity Score | Property Crimes |
| | Violent Crimes |
| | Sex Crimes |
| | Traffic Violations |
| | Fraud Activity \| Complaints |
| Sentiment Score | Emotive Communications on Social |
| | Language on Communication Apps |
| | Device Behavior |
| | Search Statistics |
| | Heart Rate \| Apple Device |
| Community Infra | Town Population |
| Score | % Town Impacted |
| | Proximity to Large City |
| | Average Home Value |
| | Average Salary |
| Economic Costs | Economic Value of Requested Claims |
| Score | Time Horizon, Economic Impact of No |
| | Fulfillment of Claims |
| | Basket of Goods vs. Medical Bills, |
| | Medical Bills higher economic value |
| | and high impact on accelerating recovery |

Use case 1: Guest request use of a home on AirBnB under the claim that they are impacted by the California wildfires.
Claim: Access to Open Homes Listing on AirBnB provided by homeowners who want to help individuals displaced by California wildfire.
Outcome: A validity threshold of the AVS to initiate approval of the transaction.
Variables Signals Pre Booking
   Address verification of requestor
   Affordability of AirBnB home based on income level [5M home rented but income level only to substantiate a 250K home based on lifestyle]
   Location and trajectory of California wildfires
   Device location of requester
   Air quality in proximity to requester device location
   Timing of requester booking to event claim [family reunion]
   Statistical probability of people with asthma [google search compared to claim]
   Family size based on linked in social networks
   Previous behaviors, complaints, score on AirBnB
   Scores and comments on other platforms, Uber, LinkedIn, FB, Instagram
Variables Signals During Booking to ensure Integrity of Provided AVS
   Social Postings, Individual and activity at address
   Density of activity at location 13 people vs. 100 people
   Formal complaints to authorities
   Sentiment commentary within NextDoor for particularly home location

Use case 2: Individual(s) request a basket of goods via a Branded Website [Everest—Walmart] to support their basic needs during after being impacted by COVID-19
Claim: Access to goods that are purchased by the good intentions of others, is made available to individuals who have been validated that they need those goods and cannot reasonably purchase those goods themselves.
Outcome: A validity threshold of the AVS to initiate approval of a request for access.
Variables Signals Pre-Request for Access to Goods
   Address verification of requestor
   Ownership or Not of home
   Value of home and average income of area
   Number of children, Age of Kids
   Items Needed for Kids of Said ages [pedialyte]
   Employed before COVID-19 Impact [before February 1t]
   Unemployment claims in last 3 months
   Social channels, pictures of children
   Natural language detection in postings to support claim of single, unemployed
   mother and 5 kids
   Device location of requester
   Family size based on linked in social networks
   Previous behaviors, complaints, score on AirBnB|Uber, Other
   Scores and comments on other platforms, Uber, LinkedIn, FB, Instagram
Variables Signals During Booking to ensure Integrity of Provided AVS
   Social listening of requester, postings, Individual and activity at address, sentiment
   Reselling or posting of any listed good that were provided access to
   Other requests for support across other marketplaces [Social Benefits, RedCross, CrowdFunding]

Use case 3: Individual(s) are burdened by medical debt and list their outstanding bills as a need with the goal of getting help paying it off. This assumes that access to help with medical bills is more of a critical need than providing cash or basic goods; medical bills provide relief in perpetuity vs. 1× relief.
Claim: Confirmation that medical bills posted by debt collectors and individuals to receive payoff contributions, are legitimate requests.
Outcome: A validity threshold of the AVS to initiate approval of the listing and transaction.
Variables|Signals Pre Booking
   Assume medical bills will be provided by debt collectors, so validity of medical bill is confirmed
   Aging of medical bills, payment attempts
   Ratio of medical spending relative to other spending
   Total debt relative to medical debt
   Credit score
   Unexpected, uninfluential events impacting individuals lifestyle (i.e., a bad divorce could have created a need vs bad life decisions)
   Categories of transactions and expenditures [cards, banks etc.], to assume excess money is not spent
   Pharmaceutical prescriptions, frequency of purchasing and refilling
   LinkedIn profiles average income
   Address verification of requestor
   Ownership or Not of home
   Value of home and average income of area
   Number of children, Age of Kids
   Unemployment claims in last 3 months
Variables|Signals During Booking to ensure Integrity of Provided AVS
   Additional medical bills created post predetermined date
   Categories of transactions and expenditures [cards, banks etc.], answers

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by processor(s) 112 as well as data that may be manipulated by processor(s) 112. The electronic storage may comprise floppy disks, hard disks, optical disks, tapes, or other storage media for storing computer-executable instructions and/or data.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although illustrated in FIG. 1 as a single component, any of the components may include a plurality of individual components (e.g., computer devices and/or code portions) each programmed with at least some of the functions described herein. In this manner, some components of computer system and/or associated user devices may perform some functions while other components may perform other functions. Furthermore, it should be appreciated that although the various instructions are illustrated in FIG. 1 as being co-located within a single processing unit, multiple processing units may be used, and one or more instructions may be executed remotely from the other instructions.

The various components illustrated in FIG. 1 may be coupled to at least one other component via any suitable network(s), which may include any one or more of, for instance, wired and/or wireless networks, including the Internet, an intranet, and/or other networks. In FIG. 1, as well as in other drawing Figures, different numbers of entities than those depicted may be used. Furthermore, according to various implementations, the components described herein may be implemented in hardware programmed with computer software instructions that configure the hardware to perform the functions described herein.

The one or more databases described herein may be, include, or interface to, any suitable electronic data storage system and may comprise one or more such databases that reside in one or more physical devices and in one or more physical locations. The one or more databases may store a plurality of types of data and/or files and associated data or file descriptions, administrative information, or any other data in accordance with various data schemas.

For purposes of explanation, numerous specific details are set forth in order to provide a thorough understanding of the description. It will be apparent, however, to one skilled in the art that implementations of the disclosure can be practiced without some of these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

1. A computer system for matching donors and donees, the system comprising:
at least one processor;
an event management module configured to enable a system administrator to create and manage system supported events, wherein each event represents a particular natural or man-made disaster or crisis that has adversely impacted multiple individuals, and wherein donees are those individuals who claim a need as a result of being impacted by one of the events; and
a computer-readable storage medium having instructions stored thereon which are executable by the at least one processor and which when executed, cause the processor to:
present a first graphical user interface including a portion allowing a first donee to register with the system;
present a second graphical user interface including a portion allowing the first donee to select a first event representing a first natural or man-made disaster or crisis that has impacted the first donee;
present, in response to the first donee selecting a first event, a third graphical user interface including a portion displaying one or more resource types associated with the first event by the system, and allowing the first donee to select a first resource type of the displayed resource types;
present, in response to the first donee selecting a first resource type, a fourth graphical user interface including a portion displaying one or more resources associated with the first event by the system, and allowing the first donee to identify the first donee's needs related to the first event from the displayed resources;
execute a validation algorithm to validate the first donee's identity and the first donee's identified needs, wherein the validation algorithm comprises a detection and decisioning algorithm configured to automatically obtain data regarding the first donee, the identified needs and the first event and generate a needs score according to rules stored in the system to assess the first donee's integrity for the identified needs for the first event;
present a fifth graphical user interface portion displaying the verified needs of the first donee based on the result of the executed validation algorithm; and
present a sixth graphical user interface portion allowing a first donor to fulfill at least some of the verified needs of the first donee.

2. (canceled)

3. (canceled)

4. The system of claim 1 further comprising an electronic marketplace for matching donees and donors, including an ecommerce component including a seventh graphical user interface allowing the first donee to create an electronic shopping basket, as part of the first donee's identification of needs related to the first event, with specific items and an eighth graphical user interface allowing the first donor to identify the first donee and purchase the specific items in the electronic shopping basket for the first donee.

5. The system of claim 4 wherein the items comprise a subset of items available from a trusted third party retailer, and the validation algorithm comprises a portion configured to validate the third party retailer.

6. The system of claim 1, further comprising a resources/needs matching component, a set of application programming interfaces (APIs) to an ecommerce platform, a rules engine adapted to create and store the rules used by the validation algorithm, a scoring module adapted to generate the needs score and a data management module adapted to obtain, manage, and store data needed by the system.

7. The system of claim 1, wherein the computer instructions, when executed, further cause the processor to:
determine, via a resource filter module. the resources associated with the first event based on characteristics of the first event.

8. The system of claim 7, comprising one or more event templates stored in the computer-readable storage medium and which are configured to provide a consistent set of information and rules for particular event types.

9. The system of claim 1 wherein for each event, the system stores event information including event type and information regarding one or more of the magnitude, geographic scope and other event information.

10. The system of claim 9 wherein graphical user interface displaying one or more resource types associated with the first event further comprises displaying a plurality of resource types associated with the first event.

11. The system of claim 6, wherein the resources/needs matching component comprises a ninth graphical user interface allowing the first donee to publish the first donee's needs related to the first event through the system and a tenth graphical user interface allowing donors to find the first donee, view the first donee's needs, select the first donee, and make resources available to meet the first donee's needs.

12. The system of claim 1, further comprising a set of APIs to facilitate the ability for donees and donors to automatically be connected to predetermined ecommerce platforms or other online systems through which needed resources may be obtained, the fourth graphical user interface comprising a portion allowing a first donee to view and select resources available from at least one of the predetermined ecommerce platforms or other online systems, and further comprising an ecommerce basket for storing and displaying the resources selected by the first donee.

13. The system of claim 12, wherein the fourth graphical user interface comprises a portion allowing the first donor to view and select some or all of the resources in the ecommerce basket and buy the resources for the first donee.

14. The system of claim 1, comprising a rules engine adapted to create and store rules relating to needs verification, a scoring module adapted to generate a needs score; and a validation module adapted to generate a validity score to assess the validity of a donee's needs for an event.

15. The system of claim 14, wherein the rules engine comprises electronically stored rules relating to validating events, and the instructions further cause the processor to:
determine the suitability of resources prior to the first donee's selection of one or more resources; and
determine what resources are displayed or accessible to the donee via the fourth graphical user interface as the one or more resources associated with the first event.

16. The system of claim 15 comprising a scoring module configured to generate one or more scores by applying the rules for a given event type using data about the first event and the first donee.

17. The system of claim 1 comprising a data management module that obtains, manages, and stores data needed by the system, including one or more data about events, donors, donees and resources.

18. The system of claim 1, the instructions further cause the processor to present, in the fourth graphical user interface, links to sources of the one or more resources.

19. (canceled)

20. The system of claim 1, wherein the system allows a second donee to register with the system, select the first event, and identify the second donee's needs related to the first event, and the instructions further cause the processor to:
generate a second needs score to assess the second donee's integrity for the identified needs for the first event;
generate a relative ranking of the first and second donees identifying which is more in need; and
based on the generated relative ranking, displaying, on the fifth graphical user interface, the donee with greater need in a higher ranked position.

21. The system of claim 1, further comprising a rules engine adapted to create and store the rules used by the validation algorithm; and a scoring module adapted to generate the needs score, wherein the needs score comprises one or more scores based on stored rules for a given event type and data about the first event and the first donee.

22. The system of claim 21, wherein the needs score comprises an access verification score, the access verification score generated based on a set of criteria from the following; the validity that the first event occurred; a probability the first donee was impacted by the first event; a credibility of the magnitude of the first donee impact; a weighted value of first donee need; and a confirmation of first donee identity.
